(19) United States
(12) Patent Application Publication
(10) Pub. No.: US 2009/0134982 A1
(43) Pub. Date: May 28, 2009

(54) SYSTEM AND METHOD FOR DISTRIBUTING ALERT NOTIFICATIONS

(75) Inventors: Blake Robertson, Reisterstown, MD (US); Jason Volk, North Bethesda, MD (US)

Correspondence Address: Blake Robertson, Suite 1325, 11785 Beltsville Drive, Beltsville, MD, 20705, US

(73) Assignee: ALERTUS TECHNOLOGIES, LLC, Beltsville, MD (US)

(21) Appl. No.: 12/324,831

(22) Filed: Nov. 26, 2008

Related U.S. Application Data
(60) Provisional application No. 60/990,607, filed on Nov. 27, 2007.
(60) Provisional application No. 60/990,614, filed on Nov. 27, 2007.

(51) Int. Cl. G08B 27/00

(52) U.S. Cl. 340/326

(57) ABSTRACT

A system and method for providing an alert notification are disclosed. A computer-readable storage medium according to one embodiment has instructions for configuring an alert text, configuring at least one audible alert instruction, and configuring at least one visible alert instruction. The computer-readable storage medium also has instructions for constructing an alert notification, and delivering the alert notification to at least one intended recipient device. The alert notification message includes the alert text, the at least one audible alert instruction, and the at least one visible alert instruction.

This application claims the benefit under 35 U.S.C. §119(e) of U.S. Provisional Application No. 60/990,607 entitled “System and Method for Controllably Distributing Alert Notifications” and U.S. Provisional Application No. 60/990,614 entitled “Alert Device Having Event-Driven Customizable Settings,” both filed Nov. 27, 2007.

### TECHNICAL FIELD

The present disclosure is directed to a system and method for distributing alert notifications and, more particularly, to a system and method for controllably distributing alert notifications having customizable alert profiles.

### BACKGROUND

Alert devices exist in a variety of settings to inform people of, for example, emergency conditions, weather conditions, and any other information relevant to the users of the alert device (i.e., non-emergency conditions). These alert devices typically include visible and/or audible alert components that are activated in response to a particular event. For example, a typical smoke detector sounds a loud alarm when it receives a signal from a sensor, the signal indicating that smoke from a fire may be detected at or around the smoke detector. In another example, a typical fire alarm sounds a loud alarm and activates a bright strobe light when it receives a signal from a fire detection network indicating that someone has triggered another fire alarm within the network. In yet another example, a typical weather radio receiver plays an alarm tone and displays a message on a text display when it receives a radio signal on a frequency reserved for emergency weather alerts. The latter two examples above depict alert devices connected to receive alert signals from remote sources, either through a wired network (i.e., in the example of the fire alarm) or through a wireless network (i.e., in the example of the weather radio receiver).

The inventors have found that alert devices typically function to inform people of a particular type of situation. Accordingly, they are configured to emit sounds and activate lights at intensities and patterns appropriate to their function. Continuing the above example of the fire alarm, the fire alarm activates bright lights and a loud siren to inform people that a potentially life-threatening situation (i.e., a fire) exists. Upon hearing the siren and/or seeing the lights, people know that they should seek safety by staying low to avoid smoke inhalation and trying to evacuate. The inventors have found that the response of people to the fire alarm, however, would not be appropriate in all emergency situations. For example, if the fire alarm were to be activated when a tornado is approaching, people evacuating in response to the alert would potentially be putting themselves in a life-threatening situation, rather than avoiding one. Thus, while the fire alarm in the above example is useful to alert people of a potential fire, it should not be used to alert people of all emergency situations. Many different types of situations (e.g., fires, tornadoes, active shooters, weather alerts, etc.) can be indicated by different alert devices. It would be inefficient and impractical, however, to administer separate alert devices for each type of alert situation.

Further, alert devices are typically activated either autonomously (e.g., as in the example of the fire alarm), or in response to a transmitted alert notification from an agency or other authority (e.g., as in the example of the weather radio receiver). Because emergency situations, non-emergency situations, and information relevant to a localized group of people may occur in specific locations, there is a need for an alert notification system capable of distributing alert notifications to one or more specified alert devices at specific locations. For example, sites such as college and university campuses, military installations, and parks can experience localized emergency or non-emergency situations that require dissemination of information to a large group of people distributed about the site. With such an alert notification system, an alert notification could be sent to alert devices distributed about the site to quickly and efficiently disseminate information to the people at the site.

One alert notification system designed for use in well-defined geographic regions is disclosed in US Patent Application Publication Number 2006/0022819 (the '819 publication) by Vincent Granny et al., published on Feb. 2, 2006. The '819 publication discloses a system and method that enables Public Safety agencies to issue alerts specific to a geographically-defined area, which can then be received by alert receiving devices (ARDs), and used by those ARDs that are located within the defined area. More specifically, the '819 publication discloses an Alert Encryption Device (AED) that is a combination of a hardware key and software intended for use on a personal computer. A user of the AED executes a program on the personal computer to send an encrypted alert data stream to ARDs. The AED program uses a combination of the hardware key and a password obtained from a registration agency to encrypt the data stream. The data stream includes the agency password, an operator password, latitude/longitude pairs of each vertex defining a rectangular geographic region within which ARDs should act upon receiving the data stream, a warning/alert code indicating the actions an ARD should take upon receiving the data stream, and a validation trailer. Each warning/alert code has a predetermined message and action. More specifically, the alert code indicates to an ARD within the rectangular geographic region defined by the latitude/longitude pairs how to respond to the data stream (i.e., using on-board components, including a piezo-electric audio transducer, a blinking white strobe, a two-line liquid crystal display for displaying a predetermined message corresponding to the alert code, and a speaker). The user of the AED chooses a message type by clicking a “radio button” in the software, and dispatches the data stream. The data stream is encrypted, as discussed above, and transmitted to an Emergency Alert System (EAS) broadcast station for transmission to the ARDs via either a broadcast FM subcarrier digital paging service or a broadcast FM subcarrier digital subscription information service.

While the system and method of the '819 publication may provide alert notifications to alert devices within a specific geographic area, its application may be limited. Specifically, because the messages of the '819 publication may consist of only the agency password, an operator password, latitude/longitude pairs of each vertex defining the rectangular geographic region within which ARDs should act upon receiving the data stream, a warning/alert code indicating the actions an ARD should take upon receiving the data stream, and a validation trailer, the messages of the '819 publication may not be sufficiently customizable to be applicable in substantially all alert situations. More specifically, because the messages of the '819 publication do not allow the operator to specify a customized message and/or choose a type of response by receiving ARDs, the messages may lack sufficient customizability to deliver alert notifications for the wide variety of situations and information that may be desired. For example, the system of the '819 publication may not allow the operator to specify a blinking pattern of the white strobe and/or a tone or volume of the piezo-electric audio transducer. In another example, the system of the '819 publication may not be suitable for delivering alert notifications having dynamic messages, such as the current temperature and weather status supplied by weather updates. These and other types of customizability may be desired by organizations wishing to utilize a system to alert a large number of people (e.g., employees, students, etc.) of any type of alert situation, including both emergency and non-emergency alert situations.

The system of the '819 publication may be further limited by its method of message dispatch. More specifically, because the system of the '819 publication may require the use of an EAS broadcasting station, alert notifications may be sent by this system only when the EAS broadcasting station has agreed to transmit the alert notifications. As a result, it may be difficult or impractical for a large number of organizations to utilize the system of the '819 publication independently of each other. This may also limit applications of the system of the '819 publication to emergency situations that the EAS broadcasting station is authorized to respond to with a broadcast. That is, the EAS broadcast station may not be authorized to transmit messages relating to non-emergency alerts that an organization may wish to disseminate amongst a particular population (i.e., people on a campus of the organization). Further, because the system of the '819 publication is designed for use exclusively with FM transmissions, the locations of the alert devices may be limited to areas where the FM signal strength is powerful enough to reliably transmit messages, and where FM signals can be received.

The system of the '819 publication may be limited also by its inflexibility. More specifically, because the system may target only devices designed to receive messages of the format described above, it may not allow for flexibility in the use of peripheral devices (i.e., devices connected to but separate from the ARDs) or other alert services. For example, because of the limited structure of these messages, an operator who transmits one of these messages may not be able to choose to activate a digital sign in response to the message (i.e., to display the message to a broader population). In another example, an operator who transmits one of these messages may not be able to choose to activate a text messaging service to contact people on an individual basis and notify them of the alert message.

The system of the '819 publication may be limited further still by its method of geographic localization. More specifically, because alert notifications may be localized only by geographic vertices (i.e., latitude/longitude pairs) defining a rectangular geographic region, the system of the '819 publication may deliver messages to alert devices that are within only the defined rectangular geographic region, which may include devices that are not intended to receive the messages. Moreover, one or more alert devices that are desired recipients of a particular alert notification may not receive the notification if they are not within the defined rectangular geographic region. That is, it may be difficult or impossible to define a rectangular geographic region that includes substantially only those devices that are intended to receive the message. Such a level of specificity may be desired in any number of emergency situations such as, for example, an evacuation of a building due to a chemical spill in that building. In this example, it may be undesirable to instruct occupants of neighboring buildings to evacuate unnecessarily, which could lead to confusion, panic, etc. Further, the system of the '819 publication may not allow for a single message to be broadcast to devices in different but similar locations, and not those devices in between (i.e., only to the devices in two buildings of a campus, but not in others).

The system and method of the present disclosure is directed to overcoming one or more of the problems set forth above.

### SUMMARY OF THE INVENTION

One aspect of the present disclosure is directed to a computer-readable medium, tangibly embodied, for providing an alert notification. In one embodiment, the computer-readable medium may be encoded with computer-readable instructions for configuring an alert text, configuring at least one audible alert instruction, and configuring at least one visible alert instruction. The computer-readable instructions preferably also include instructions for constructing an alert notification, and delivering the alert notification to at least one intended recipient device. The alert notification may include the alert text, the at least one audible alert instruction, and the at least one visible alert instruction.

Another aspect of the present disclosure is directed to a method for providing an alert notification. The method preferably includes configuring an alert text, configuring at least one audible alert instruction, and configuring at least one visible alert instruction. The method may also include constructing an alert notification, and delivering the alert notification to at least one intended recipient device. The alert notification may include the alert text, the at least one audible alert instruction, and the at least one visible alert instruction.

### BRIEF DESCRIPTION OF THE DRAWINGS

FIG. 1 is a block illustration of an exemplary disclosed computer system for providing an alert notification according to one embodiment of the present invention;

FIG. 2 is a block illustration of an exemplary disclosed alert notification architecture as provided by the computer system of FIG. 1;

FIG. 3 is a flowchart illustration of an exemplary disclosed method for providing an alert notification according to one embodiment of the present invention;

FIG. 4 is a schematic illustration of a first exemplary disclosed user interface of the computer system of FIG. 1;

FIG. 5 is a schematic illustration of a second exemplary disclosed user interface of the computer system of FIG. 1; and

FIG. 6 is a schematic illustration of a third exemplary disclosed user interface of the computer system of FIG. 1.

### DETAILED DESCRIPTION

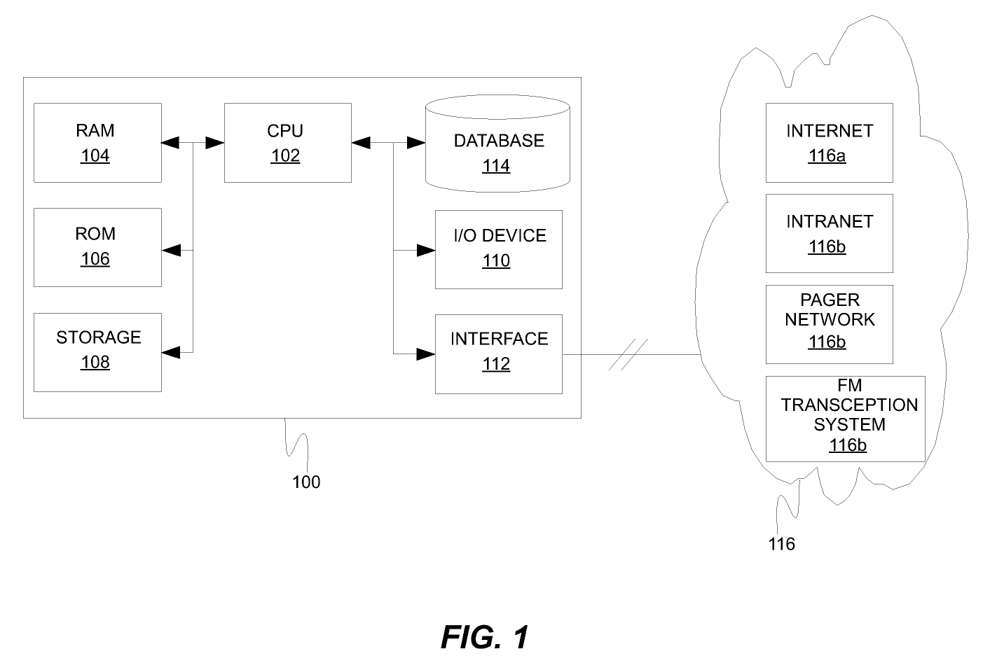

FIG. 1 illustrates a computer system 100 for creating and delivering alert notifications to one or more alert devices. Computer system 100 may include a central processing unit (CPU) 102, a random access memory (RAM) 104, a read-only memory (ROM) 106, a storage device 108, an input/output device 110, an interface 112, and at least one database 114. It is contemplated that computer system 100 may alternatively include additional, fewer, or different components than those listed above. It is also contemplated that one or more of the components listed above may be implemented as hardware, software, or a combination of hardware and software.

CPU 102 may include one or more processors, each configured to execute computer program instructions and process data to perform various processes consistent with the present disclosure. As illustrated in FIG. 1, CPU 102 may be communicatively coupled to RAM 104, ROM 106, storage device 108, input/output (I/O) device 110, interface 112, and database 114. For example, the computer program instructions may be loaded into RAM 104 from ROM 106 for execution by CPU 102, as is known in the art. As will be described further below, the computer program instructions executed by CPU 102 may include instructions for running an alert notification system.

RAM 104 and ROM 106 may each include one or more devices for storing information associated with an operation of computer system 100 and CPU 102. RAM 104 may include a memory device for storing data associated with one or more operations of CPU 102. ROM 106 may include a memory device configured to access and store information associated with computer system 100, including information for creating and monitoring one or more processes.

Storage device 108 may embody any type of mass storage device capable of storing information that may be used by CPU 102 to perform the processes consistent with the present disclosure. For example, storage device 108 may include one or more magnetic and/or optical disk devices, such as, for example, hard drives, CD-ROMs, DVD-ROMs, or any other type of mass media storage devices. The information stored by storage device 108 may include, for example, an encryption key for use by CPU 102 to encrypt alert notifications. It should be appreciated that storage device 108 may include ROM 106, if desired.

Computer system 100 may interface with a user via I/O device 110 and/or interface 112. More specifically, I/O device 110 may include one or more components configured to communicate information with a user of computer system 100. For example, I/O device 110 may include a keyboard and a mouse configured to allow a user to input parameters associated with computer system 100. I/O device 110 may also include a computer display device such as, for example, a computer monitor including a graphical user interface (GUI) for outputting information and accepting input. I/O device 110 may additionally include peripheral devices such as, for example, a printer for printing information and reports associated with computer system 100, a user-accessible disk drive (e.g., a USB port, a floppy, CD-ROM, or DVD-ROM drive, etc.) to allow a user of computer system 100 to input data stored on a portable media device, a microphone a speaker system, or any other suitable type of interface device.

Interface 112 may include one or more components configured to transmit and receive data via a communication network 116, such as the Internet 116a, an intranet 116b, a pager network 116c, and a Frequency Modulation (FM) transception system 116d. Although not shown, it is contemplated that interface 112 may additionally or alternatively be configured to transmit and receive data via a local area network, a work-station peer-to-peer network, a direct link network, a wireless network, Wi-MAX, HD-radio, digital over-the-air transmissions, cable, satellite networks, cellular networks, or any other suitable communications channel. It is contemplated that computer system 100 may utilize any appropriate communications protocols for the one or more communications channels utilized. It should be appreciated that, in this manner, computer system 100 may communicate with other computer systems (i.e., client machines) through the use of a network architecture (not shown), as is known in the art. For example, network interface 112 may allow users of other computers to access a web server of computer system 100. It should also be appreciated that network interface 112 may embody any type of wired or wireless network interface such as, for example, an Ethernet port or a Wi-Fi network adaptor.

Database 114 may include one or more software and/or hardware components that cooperate to store, organize, sort, filter, and/or arrange data used by computer system 100 and CPU 102. By way of example and not limitation, as will be described further below, database 114 may contain a listing of alert devices and associated identifiers of alert devices, a listing of geographic locations of alert devices, a listing of groups of alert devices, a listing of alert device groups to which each alert device belongs, a listing of alert profiles and settings associated with each alert profile, and a listing of authorized users of the web server of computer system 100 and their associated passwords. State of the art security measures may be taken to protect passwords and other authentication features. CPU 102 may use database 114 to store data entered by users of computer system 100 (i.e., via I/O device 110 or network interface 112), and to generate alert notifications for delivery to one or more alert devices. It is contemplated that database 114 may alternatively include a plurality of databases, if desired.

Computer system 100 and the components thereof may generally work in concert to provide a computer application, which may be accessed by users of computer system 100. The computer application of computer system 100 may embody one or more stand-alone applications, web-applications, or any combination thereof. As such, it should be appreciated that the computer application of computer system 100 may include any number of computer modules, programs, applications, scripts, processes, threads, or code sections that may functionally interrelate with each other to provide the disclosed functionality, such as, for example, web server code. For example, these modules, etc., may be implemented in whole or in part using any combination of software such as commercially available software tools, custom code written in programming languages such as C, C++, C#, and Java, custom code written in scripting languages such as JavaScript, and custom code written in server programming languages such as JSP, ASP, and PHP. It is contemplated that these modules, etc., may be alternatively or additionally be implemented in whole or in part by any combination of hardware such as discrete electrical components, or as one or more hardwired application specific integrated circuits (ASIC) that are custom designed for this purpose.

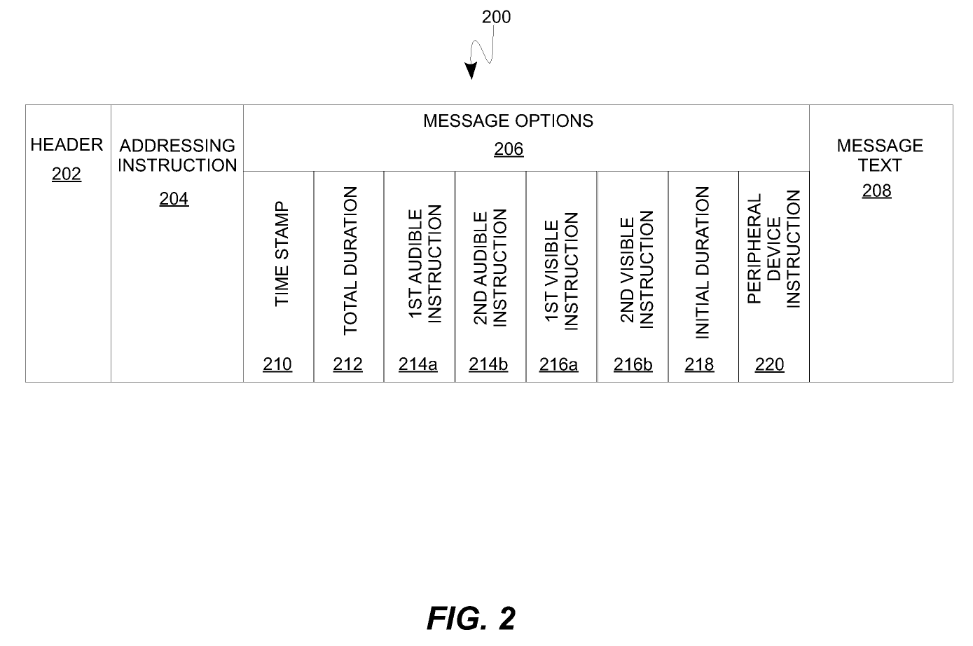

The components of computer system 100 may generally function to provide an alert notification. FIG. 2 illustrates an exemplary alert notification architecture 200 for sending alert notifications. Alert notification architecture 200 may include a header 202, an addressing instruction 204, a plurality of message options 206, and a message text 208. It is contemplated that alert notification architecture 200 may additionally include other fields, settings, or delimiters, if desired. Alert notification architecture 200 may be encoded or encrypted in any manner known in the art, and may generally comprise a series of bytes. It is contemplated that a size of alert notification architecture 200 may be adjusted to suit one or more communications channels of communication network 116. For example, a communications channel may accommodate messages of a maximum size of about 390 bytes, and computer system 100 may limit the size of alert notification architecture 200 to about 390 bytes. It is also contemplated that some communications channels may have highly-restrictive size limitations and that alert notifications may alternatively be divided (e.g., by computer system 100) into multiple segments to accommodate the size limitations of such communications channels. For example, a particular communications channel may limit messages to 160 bytes. Computer system 100 may prepare alert notifications for transmission across the size-restrictive communications channel by dividing the alert notifications into sequential 160 byte or fewer segments. The alert notifications may then be reconstructed by potential recipient devices.

Header 202 may include information about and/or for use with a given alert notification constructed according to alert notification architecture 200. For example, header 202 may include an organization identifier such as a number corresponding to the identity of an organization that administrates computer system 100, a user identifier such as a number corresponding to the identity of the user of computer system 100 that prepared the alert notification, and metrics regarding the alert notification such as a length of alert notification architecture 200 and/or a length of the alert notification. It should be appreciated that header 202 may additionally include other fields, settings, or delimiters, if desired.

Addressing instruction 204 may include information indicating at least one intended recipient device of the alert notification. More specifically, addressing instruction 204 may include information indicating whether or not a device that receives the alert notification should act on the alert notification. In this manner, the alert notification may be sent to one or more devices, and be acted upon by those devices indicated by addressing instruction 204 and substantially ignored by those devices not indicated by addressing instruction 204. In one example, addressing instruction 204 may include one or more unique identifiers assigned to each intended recipient device, where each potential recipient device (i.e., each alert device in communication with computer system 100) is aware of its unique identifier (i.e., the unique identifier may be stored in a memory of the device). In another example, addressing instruction 204 may include one or more unique identifiers each assigned to a group of intended recipient devices, where each potential recipient device is aware of the one or more groups of which that potential recipient device is a member (i.e., the unique identifiers of each group of which a device is a member may be stored in a memory of the device). In this manner, alert devices may be grouped based on one or more grouping methodologies. That is, groups may be defined by one or more users of computer system 100 to include alert devices based on categorical (e.g., alert devices in dormitory buildings), geographical (e.g., alert devices in the southern portion of a campus), or any other grouping, if desired.

Addressing instruction 204 may alternatively include information identifying, for example, one or more geographic regions within which the at least one intended recipient device may reside, where each potential recipient device is aware of its location (i.e., the device may include an algorithm to determine whether its location falls within the one or more geographic regions indicated by addressing instruction 204). For example, a latitude and longitude of a potential recipient device may be stored in a memory of the potential recipient device. A location of a potential recipient device may alternatively be determined based on, for example, a geographical information system, such as a GPS device included with or communicatively coupled with the potential recipient device, or any other method known in the art. In yet another example, a location of a potential recipient device may be defined via a graphical user interface of computer system 100, and sent to the potential recipient device by computer system 100.

Intended recipient devices may alternatively be addressed by addressing instruction 204 based on whether they are indoors or outdoors. That is, addressing instruction 204 may include an indicator that only outdoor devices are intended recipient devices of the alert notification, or an indicator that only indoor devices are intended recipient devices of the alert notification. This mode of addressing may be useful, for example, during a lightning advisory. More specifically, a first alert notification may be addressed to outdoor devices to instruct people to seek shelter, while a second alert notification may be addressed to indoor devices to instruct people to remain indoors.

It is contemplated that addressing instruction 204 may alternatively use an inclusive or exclusive combination of any of the above-described modes to indicate the intended recipient devices. For example, addressing instruction 204 may address only those recipient devices that are within a given geographical region, but are not also members of a given categorical grouping (i.e., the alert message would be substantially ignored by devices that are both within the geographical region and members of the categorical grouping). It is further contemplated that intended recipient devices may be addressed in any other manner known in the art, such as, for example, only those devices that are not currently displaying any message may be addressed. It should be appreciated that addressing instruction 204 may include any other information which may identify the at least one intended recipient device and that each potential recipient device may be programmed to determine whether it is indicated by addressing instruction 204 in any way known in the art.

Message options 206 may include a plurality of settings for use by intended recipient devices in response to receiving the alert notification. For example, message options 206 may include information for use by intended recipient devices to determine what visible and/or audible alerts should be activated in response to receiving the alert notification, how long the alert notification should be acted upon, and what text should be displayed in response to receiving the alert notification. More specifically, message options 206 may include a time stamp 210, a total duration 212, first audible alert instruction 214a, second audible alert instruction 214b, first visible alert instruction 216a, second visible alert instruction 216b, an initial duration 218, a peripheral device instruction 220, and a message text 208. It should be appreciated that alert notification architecture 200 may include any combination of the above components and may additionally or alternatively include other components consistent with the present disclosure. It is contemplated that peripheral device instruction 220 may be directed toward a specific peripheral device, or to a class of peripheral devices. That is, peripheral device instruction 220 may be capable of indicating activation of a variety of peripheral devices based on, for example, a common activation methodology. In one example, peripheral device instruction 220 may concurrently indicate activation of visual alert devices that share a common activation methodology, such as strobes and flashing lights. In another example, peripheral device instruction 220 may concurrently indicate activation of audible alert devices that share a common activation methodology, such as sirens and buzzers. It should be appreciated that the classifications enumerated above are presented as exemplary only, and peripheral device instruction 220 may concurrently indicate activation of any number of other combinations of devices that may share a common activation methodology.

Time stamp 210 may generally include a time and/or date about equal to the time and/or date at which the alert notification was prepared by computer system 100. It should be appreciated that time stamp 210 may embody any type of indication of a time and/or date known in the art.

Total duration 212 may generally indicate a period of time over which the alert notification should be acted upon by the at least one intended recipient device indicated by addressing instruction 204. For example, total duration 212 may represent a period of time. In another example, total duration 212 may alternatively embody a time stamp indicating a time and/or date about which the at least one intended recipient device should cease acting on the alert notification. It is contemplated that total duration 212 may alternatively be omitted from alert notification architecture 200 and that intended recipient devices may cease acting upon the alert notification substantially after computer system 100 ceases to send the alert notification (i.e., as a broadcast, or in response to polling messages from potential recipient devices requesting active alert notifications).

Audible alert instructions 214a, 214b may each include an instruction indicating how the at least one intended recipient device indicated by addressing instruction 204 should activate audible alert components when acting on the alert notification. For example, audible alert instructions 214a, 214b may each include an audible alert intensity, an audible alert tone (i.e., at least one pitch and/or pattern of activation of the audible alert components), and an audible alert interval (e.g., an audible alert frequency or period). It should be appreciated that audible alert instructions 214a, 214b may alternatively or additionally include other components (e.g., one or more audio files to be played by the intended recipient devices) and that the above components are presented as exemplary only. Although shown including two audible alert instructions 214a, 214b, it is contemplated that message options 206 may include any number of audible alert instructions, if desired.

Visible alert instructions 216a, 216b may each include an instruction indicating how the at least one intended recipient device indicated by addressing instruction 204 should activate visible alert components when acting on the alert notification. For example, visible alert instructions 216a, 216b may each include a visual alert type (e.g., at least one intensity and/or pattern of activation of the visible alert components), and a visual alert interval (e.g., an audible alert frequency or period). It should be appreciated that visible alert instructions 216a, 216b may alternatively or additionally include other components and that the above components are presented as exemplary only. Although shown including two visible alert instructions 216a, 216b, it is contemplated that message options 206 may include any number of visible alert instructions, if desired.

Initial duration 218 may generally indicate a period of time over which the alert notification should be initially acted upon by the at least one intended recipient device indicated by addressing instruction 204. More specifically, initial duration 218 may represent a portion of total duration 212 during which the at least one intended recipient device may act in a first manner and after which the at least one intended recipient device may act in a second manner. For example, initial duration 218 may define an interval over which the at least one intended recipient device may act in accordance with first audible alert instruction 214a and first visible alert instruction 216a, and after which the at least one intended recipient device may act in accordance with second audible alert instruction 214b and second visible alert instruction 216b. As such, it should be appreciated that message options 206 may alternatively include a plurality of durations (i.e., for each audible alert instruction and/or for each visible alert instruction), if desired. Initial duration 218 may, for example, represent a period of time. In another example, initial duration 218 may alternatively embody a time stamp indicating a time and/or date about which the at least one intended recipient device should alter its response to the alert notification. In this manner, alert notifications constructed according to alert notification architecture 200 may include an initial alert routine (i.e., as defined by first audible alert instruction 214a and first visible alert instruction 216a) and a subsequent alert routine (i.e., as defined by second audible alert instruction 214b and second visible alert instruction 216b) where the initial alert routine may be used to get the attention of people in the area of the at least one intended recipient device and the subsequent alert routine may be used to maintain their attention. For example, the initial alert routine may instruct the at least one intended recipient device to activate loud sirens and fast blinking lights to alert people to the presence of an alert message, while the subsequent alert routine may instruct the at least one intended recipient device to intermittently emit a medium-intensity beep and slow blinking lights to indicate that the alert message is still being displayed (i.e., an emergency condition still exists). In this manner, people may be alerted to the emergency condition by the initial alert routine while being able to comfortably approach the at least one intended recipient device to read the alert message while the subsequent alert routine is executed. In another example, the initial alert routine may instruct the at least one intended recipient device to activate a low volume beep and intermittent low intensity blinking lights for a short duration (e.g., ten seconds), while the subsequent alert routine may instruct the at least one intended recipient device to silence the siren and occasionally blink the lights indicating that an announcement message is being displayed. It should be appreciated that the disclosed examples of initial alert routines and subsequent alert routines are intended as exemplary only, and that the initial alert routine and at least one subsequent alert routine may be used in any way desired by administrators of the disclosed system.

Peripheral device instruction 220 may generally indicate the activation of one or more peripheral devices that may be communicatively coupled with the at least one intended recipient device indicated by addressing instruction 204. That is, each intended recipient device may be communicatively coupled with one or more peripheral devices, the activation of which may be indicated by peripheral device instruction 220. It should be appreciated that peripheral device instruction 220 may indicate the activation of some, all, or none of the peripheral devices communicatively coupled with a given intended recipient device. For example, peripheral device instruction 220 may indicate that each intended recipient device should activate an LED marquee, if the intended recipient device is communicatively coupled with an LED marquee. Peripheral devices may include, without limitation, LED marquees, text-to-speech modules, strobes, sirens, and switches (e.g., door locks or television video source overrides). It should be appreciated that peripheral device instruction 220 may further include settings, options, and other relevant parameters, as appropriate. It is contemplated that each potential recipient device may be aware of which peripheral devices it is connected to, if any, and take the appropriate action as indicated by the received alert notification.

Message text 208 may include a text of the alert notification that may be used to provide a written message explaining the alert notification. For example, message text 208 may explain an emergency situation, provide instructions for people reading message text 208, and be displayed by the at least one intended recipient device indicated by addressing instruction 204. More specifically, message text 208 may include a response guidance message such as, for example, instructions for at least one of an evacuation, a lock down, a shelter-in-place of high elevation (e.g., near or at a roof), and a shelter-in-place of low elevation (e.g., a basement). It should be appreciated that message text 208 may include any content as specified by an operator of computer system 100.

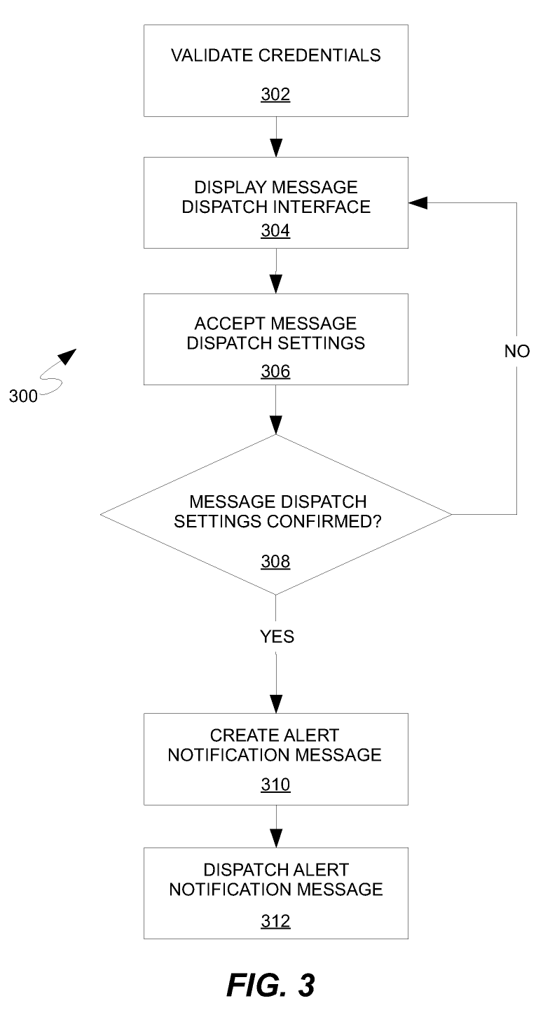

An exemplary operation of computer system 100 will now be discussed with regard to FIGS. 3-6.

### INDUSTRIAL APPLICABILITY

The disclosed computer system may be operable to construct an alert notification and deliver the alert notification to one or more intended recipient devices. In this manner, the one or more intended recipient devices may alert people of an alert situation using the components of the alert notification as instructions on how to do so. More specifically, the one or more intended recipient devices may activate audible and/or visible alert components in response to instructions included within the alert notification. Further, the one or more intended recipient devices may display a text message, provided by the alert notification, to give people a more detailed explanation of the alert situation. Further still, the one or more intended recipient devices may control one or more peripheral devices based on the components of the alert notification.

The alert notification may be prepared by a user of the disclosed computer system. More specifically, a user of the computer system may customize the components of the alert notification based on intended recipient devices, message text, audible and visible alerting instructions, and peripheral devices. The user may further choose to activate one or more alert services such as, for example, text messaging services, emailing services, and other mass communications services, in conjunction with the dispatch of the alert notification.

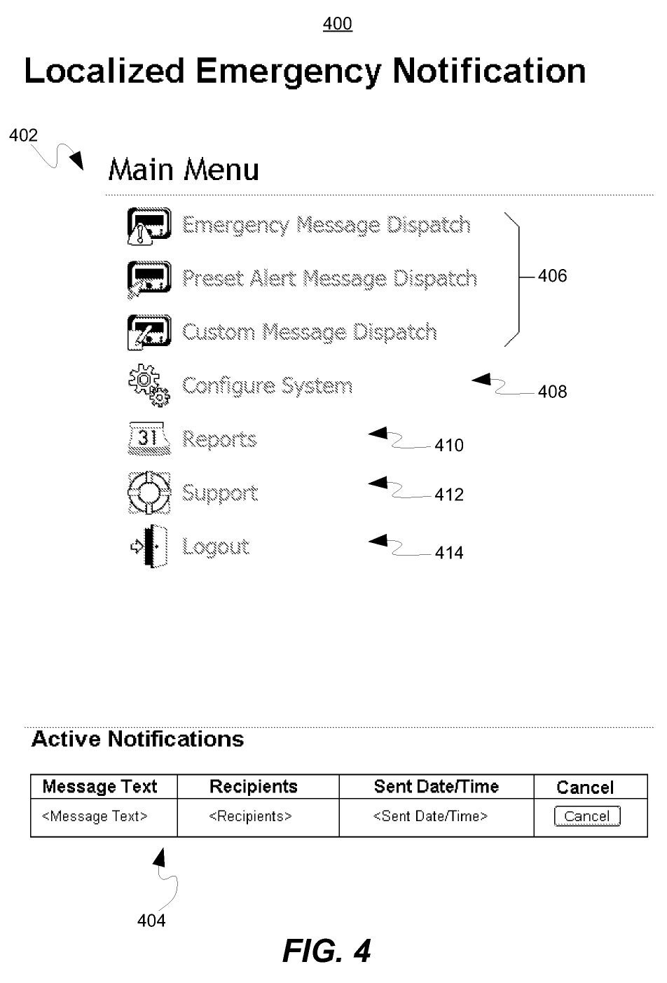

FIG. 3 illustrates a flowchart depicting an exemplary disclosed method 300 performed by computer system 100, while FIGS. 4-6 illustrate exemplary graphical user interfaces (GUIs) for use by a user of computer system 100 to facilitate an exemplary disclosed method. The various steps of method 300 are described below by name. It should be appreciated, however, that the following step names are included for clarity of description only and are not intended to imply a limitation of the scope of each step.

Computer system 100 may first perform a validation step 302. Validation step 302 may include validating the user's credentials. For example, computer system 100 may require the user to enter a username and/or password to validate the user's identity. It should be appreciated that computer system 100 may alternatively or additionally utilize any other authentication method known in the art, such as, for example, an identity document or card, a security token, a software token, a pass phrase, a personal identification number, a fingerprint or other biometric identifier, and signature or voice recognition. By validating the user's identity, computer system 100 may limit or avoid dispatch of unauthorized alert notifications. Computer system 100 may accept the user's credentials via a user interface such as, for example, a web page served by computer system 100 to a client machine used by the user.

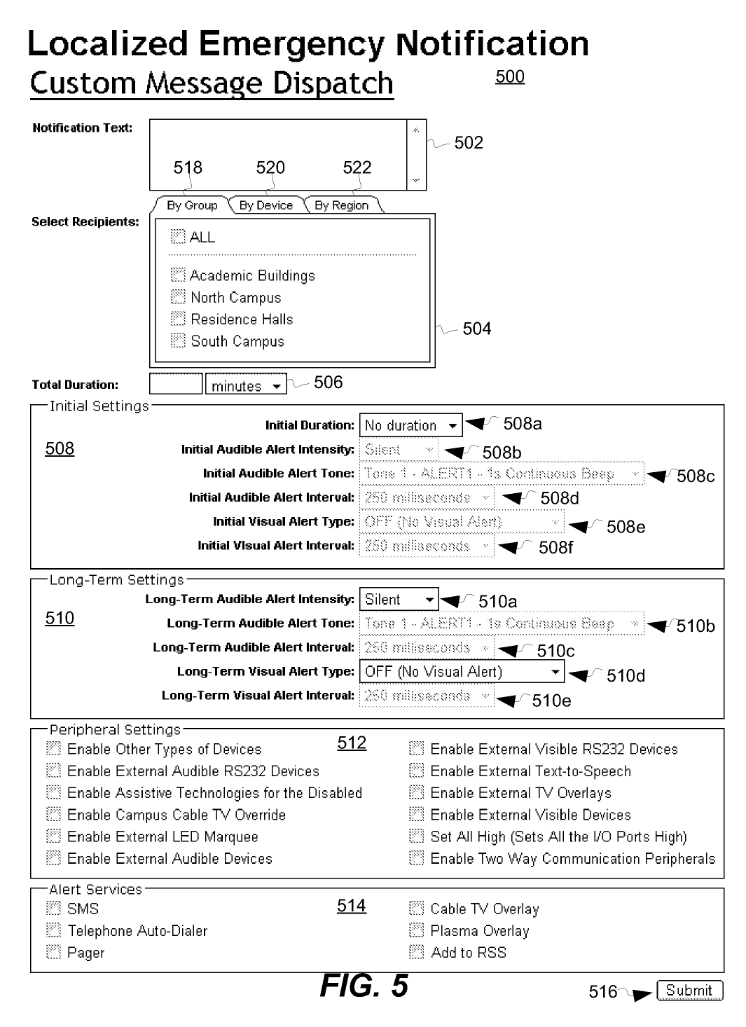

After the user identity is verified in the validation step 302, computer system 100 may present the user with a graphical user interface including a message dispatch interface in a display step 304. It should be appreciated that the message dispatch interface may be presented in response to a selection by the user (i.e., a selection from a menu interface; an exemplary menu interface is described in further detail below with reference to FIG. 4). The message dispatch interface may generally allow the user to select settings for the components of alert notification architecture 200 from a plurality of options. More specifically, the message dispatch interface may allow the user to select values for addressing instruction 204, time stamp 210, total duration 212, audible alert instructions 214a, 214b, visible alert instructions 216a, 216b, initial duration 218, peripheral device instruction 220, and message text 208. An exemplary message dispatch interface is described in further detail below with reference to FIG. 5.

Computer system 100 may then accept the message dispatch settings, as selected by the user in an acceptance step 306. For example, the user may submit the message dispatch settings by clicking a submit button provided on the message dispatch interface. It is contemplated that any or all of the message dispatch settings may be accepted by computer system 100 at a time prior to the dispatch of the alert notification. For example, the message dispatch settings may be saved as a preset message that may be chosen for dispatch by a user of computer system 100 at a later time. In another example, the message dispatch settings may be saved as a scheduled message that may be dispatched at a predetermined time in the future, the predetermined time being chosen by a user of computer system 100 (e.g., at about the same time as the selection of the message dispatch settings). In this manner, the alert notification may be prepared in advance of a foreseeable alert situation, and dispatched at an appropriate time. For example, a fire drill may be scheduled at a particular time, and the alert notification may be scheduled for dispatch shortly before the fire drill to inform and/or remind people about the fire drill and instruct people accordingly to avoid confusion, panic, etc. during the fire drill. It should be appreciated that the message dispatch settings may be stored in RAM 104 or ROM 106, and that the message dispatch settings may be encoded as appropriate. For example, the settings may be stored as coded indices of available settings, plain text, or any other encoding known in the art.

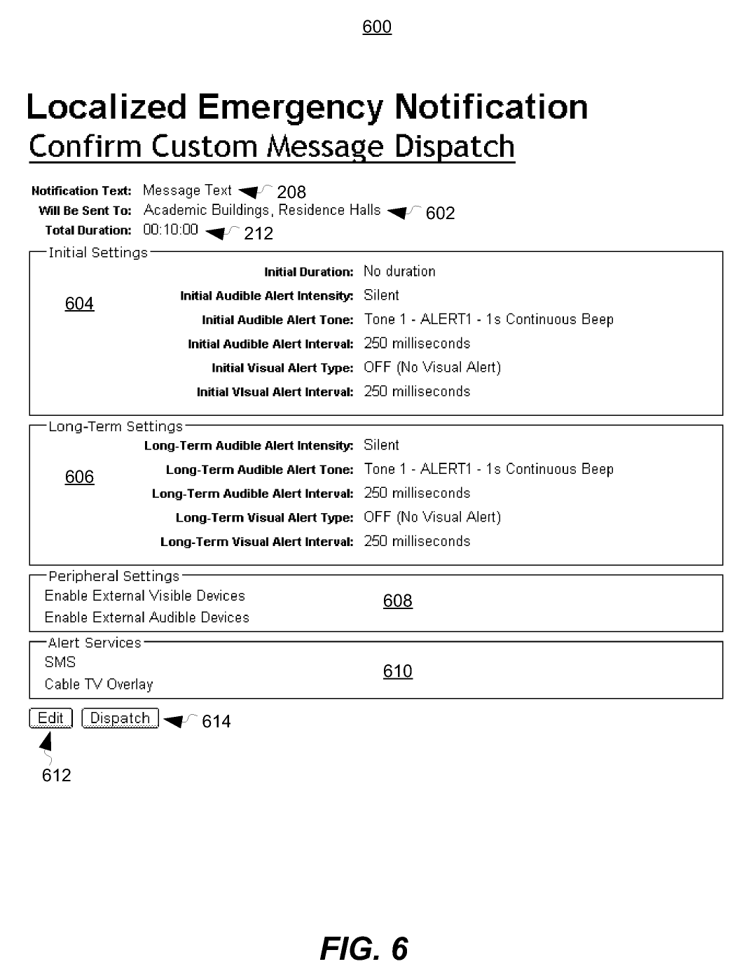

Next, computer system 100 may present the user with a message dispatch confirmation interface in a confirmation step 308. The message dispatch confirmation interface may generally allow the user to indicate an acceptance of the message dispatch settings or a desire to modify the message dispatch settings. For example, the message dispatch confirmation interface may enumerate the message dispatch settings chosen by the user and offer the user the option to accept or modify the settings. The message dispatch confirmation interface may further offer the user to cancel the alert notification altogether. If the user chooses to modify the message dispatch settings (e.g., by clicking an edit button), computer system 100 may return to display step 304. Alternatively, the message dispatch confirmation interface may allow the user to modify the message dispatch settings directly. If the user confirms the message dispatch settings (e.g., by clicking a confirm button), computer system 100 may save the message dispatch settings and generally dispatch the alert notification. Alternatively, as discussed above, computer system 100 may save the message dispatch settings for future dispatch. An exemplary message dispatch confirmation interface is described in further detail below with reference to FIG. 6.

In preparation for message dispatch, computer system 100 may create the alert notification in a creation step 310. Computer system 100 may create the alert notification based on the message dispatch settings chosen by the user. More specifically, computer system 100 may use the chosen message dispatch settings to construct the alert notification according to alert notification architecture 200. It should be appreciated that the chosen message dispatch settings may be encoded in any means known in the art, and that the alert notification may be encrypted, if desired, in any way known in the art. Computer system 100 may then dispatch the alert notification in a dispatch step 312. More specifically, computer system 100 may transmit the alert notification via interface 112. As such, the alert notification may be sent to one or more potential recipient devices via the Internet 116a, intranet 116b, pager network 116c, and/or Frequency Modulation (FM) transception system 116d. Although not shown, it is contemplated that interface 112 may additionally or alternatively transmit the alert notification via a local area network, a work-station peer-to-peer network, a direct link network, a wireless network, a point-to-point communications channel such as, for example, short message service (SMS), or any other suitable communications channel. In this manner, the various alert devices in database 114 can connect to computer system 100 via different communications channels and still receive the same alert notifications. It should be appreciated that the alert notification may be sent in any manner known in the art appropriate to desired communications channels. For example, the alert notification may be broadcast to a plurality of potential recipient devices at a time of dispatch. In another example, each potential recipient device may periodically poll computer system 100 as is known in the art, and computer system 100 may respond to the polling by sending active alert notifications to the device. In yet another example, computer system 100 may push alert notifications directly to the each intended recipient device over a point-to-point communications channel. It should also be appreciated that each potential recipient device may read addressing instruction 204 to determine whether it is an intended recipient device. Those potential recipient devices that determine they are intended recipient devices may then continue to read the alert notification and respond according to its instructions, while those potential recipient devices that determine they are not intended recipient devices may substantially ignore the rest of the alert notification.

CPU 102 may be operable to prepare and deliver the alert notification with the requested settings in a format consistent with alert notification architecture 200. More specifically, CPU 102 may set addressing instruction 204 to include the addressing settings indicated by the user. CPU 102 may also set message options 206 to include the settings indicated by the user. CPU 102 may further set message text 208 to the message text indicated by the user. CPU 102 may further still set time stamp 210 to about the time and/or date at which the alert notification was created. CPU 102 may then encrypt alert notification architecture 200 according to the encryption key stored in ROM 106. It should be appreciated that the intended recipient devices may have access to a decryption key or any other data required to decrypt the alert notification (i.e., so that they might decrypt the alert notification, once received). CPU 102 may then send the alert notification using at least one communications channels, as discussed above.

A user of computer system 100 may interface with computer system 100 through a graphical user interface (GUI). FIGS. 4-6 illustrate exemplary GUI displays of computer system 100 for use in creating an exemplary disclosed alert notification. As such, the components of alert notification architecture 200, as well as an exemplary disclosed method of selecting them, will be discussed below with regard to FIGS. 4-6.

FIG. 4 illustrates an exemplary menu interface 400 of computer system 100. Menu interface 400 may include a menu 402 of options for the user of computer system 100, and a listing 404 of active alert notifications. Menu 402 may grant the user access to any number of functionalities of computer system 100. Menu 402 may grant the user access to any number of methods via buttons, hyperlinks, text-entry commands, one or more drop-down menus, or any other method known in the art. For example, as shown in FIG. 4, menu 402 may include one or more alert notification dispatch links 406, a system configuration link 408, a reports link 410, a support link 412, and a logout link 414. Each link of FIG. 4 may direct the user to one or more GUIs such as, for example, forms and menus, in response to selection by the user. It should be appreciated that menu 402 may include additional and/or different links, if desired.

Listing 404 may include an enumeration of active alert notifications. More specifically, listing 404 may enumerate those alert notifications that have been dispatched by computer system 100 and for which their respective total duration 212 has not yet elapsed. Listing 404 may include, for example, message text 208, a list of recipients derived from addressing instruction 204, and time stamp 210 for each applicable alert notification. It should be appreciated that listing 404 may include other or different information related to each applicable alert notification. Listing 404 may further include a cancel button for each applicable alert notification, allowing the user to cancel each respective alert notification. For example, if the user chooses to cancel a given alert notification, computer system 100 may send a cancellation message to the potential recipient devices indicating that the intended recipient devices of the cancelled alert notification should cease to act on the alert notification. It is contemplated that, although not shown, listing 404 may be included on any or all GUIs of computer system 100.

FIG. 5 illustrates an exemplary message dispatch interface 500 of the web server of computer system 100. Message dispatch interface 500 may allow the user to send an alert notification to one or more alert devices. For example, message dispatch interface 500 may include a message text field 502, a recipient selection field 504, a total duration field 506, a plurality of initial settings fields 508, a plurality of long-term settings fields 510, a plurality of peripheral settings checkboxes 512, a plurality of alert services checkboxes 514, and a submit button 516. In this manner, the user may select the settings used by computer system 100 to construct an alert notification consistent with alert notification architecture 200 such that, when the alert notification is received by an alert device, the alert device may extract the settings to determine how to respond to the received alert notification.

Message text field 502 may embody any type of text field known in the art that allows the user of computer system 100 to specify message text 208. For example, message text field 502 may include a text field allowing the user to enter message text 208 using a keyboard of the client machine in communication with computer system 100. It is contemplated that the contents of message text field 502 may alternatively or additionally be populated by one or more preset message texts. For example, message dispatch interface 500 may include a preset message text selection field (e.g., a drop-down menu of preset message texts). Upon selection of a preset message text, computer system 100 may populate message text field 502 with a preset message text. It should be appreciated that the user may modify the contents of message text field 502 after populating it with a preset message text. It should also be appreciated that computer system 100 may further provide one or more interfaces for creating, modifying, and deleting available preset message texts. In this manner, the user may specify a custom message text for the alert notification, which CPU 102 may use to construct message text 208.

Message dispatch interface 500 may also allow the user to define addressing instruction 204 via recipient selection field 504. For example, recipient selection field 504 may allow the user to select one or more methods of recipient addressing such as, by group, by device id, and by region (i.e., geographic region). As shown in FIG. 5, recipient selection field 504 may include a by group tab 518, a by device tab 520, and a by region tab 522, each of which may modify the contents of recipient selection field 504 to allow the user to select intended recipient devices based on the selected method. FIG. 5 illustrates an example of what recipient selection field 504 may look like when by group tab 518 is selected. More specifically, recipient selection field 504 may include one or more check boxes each representing an alert device group (i.e., a group of potential recipient devices as defined by a user of computer system 100). Message dispatch interface 500 may additionally allow the user to select all of the alert devices in database 114 as intended recipient devices of the alert notification. In another example, message dispatch interface 500 may additionally allow the user to select specific devices (e.g., by their unique IDs) as intended recipient devices of the alert notification. In yet another example, message dispatch interface 500 may additionally allow the user to select a geographic region such as, for example, a radius about a chosen location, such that all potential recipient devices within that radius are indicated as intended recipient devices of the alert notification. Alternatively, message dispatch interface 500 may allow the user to select the geographic region by indicating the region on an on-screen map (not shown). It should be appreciated that the geographic region may alternatively be chosen in any manner known in the art. CPU 102 may use the settings of recipient selection field 504 to construct addressing instruction 204.

Total duration field 506 may generally allow the user to input a total duration of the alert notification. That is, total duration field 506 may allow the user to specify how long the alert message should be responded to by the at least one intended recipient device indicated by addressing instruction 204. It is contemplated that total duration field 506 may include a plurality of fields, a combination of which may be used by CPU 102 to determine the total duration of the alert duration. For example, as illustrated in FIG. 5, total duration field 506 may include a text input field and a drop-down menu (not labeled). The text input field may allow the user to input a numerical value while the drop-down menu may allow the user to choose a unit of time (e.g., minutes, hours, days, weeks, etc.). It is contemplated that total duration field 506 may include any number of fields accepting any types of input appropriate for setting a duration. In this manner, CPU 102 may use the settings of total duration field 506 to construct total duration 212.

Initial settings fields 508 may generally allow the user to input settings defining the initial response of intended recipient devices to the alert notification. For example, initial settings fields 508 may include an initial duration field 508a, an initial audible alert intensity field 508b, an initial audible alert tone field 508c, an initial audible alert period field 508d, an initial visible alert type field 508e, and an initial visible alert period field 508f. It is contemplated that any of initial settings fields 508 may be text fields (i.e., to allow the user to input arbitrary values), or may be selection fields (i.e., to allow the user to choose values from a set of predetermined options). In this manner, initial settings fields 508 may define initial patterns of activation of audible alert elements and visible alert elements of intended recipient devices. These initial patterns may effectively define an initial alert routine to be used to attract the attention of people around the intended recipient device, thus attracting people to the intended recipient device. It should be appreciated that CPU 102 may construct at least a portion of message options 206 based on the settings chosen in initial settings fields 508. For example, CPU 102 may use the setting of initial duration field 508a to construct initial duration 218. CPU 102 may further use the settings of initial audible alert intensity field 508b, initial audible alert tone field 508c, and initial audible alert period field 508d to construct first audible alert instruction 214a. CPU 102 may also use the settings of initial visible alert type field 508e and initial visible alert period field 508f to construct first visible alert instruction 216a.

Long-term settings fields 510 may generally allow the user to input settings defining the long-term response of an intended recipient devices to alert notification architecture 200 (i.e., the response of intended recipient devices after the initial duration has elapsed). For example, long-term settings fields 510 may include a long-term audible alert intensity field 510a, a long-term audible alert tone field 510b, a long-term audible alert period field 510c, a long-term visible alert type field 510d, and a long-term visible alert period field 510e. It is contemplated that any of long-term settings fields 510 may be text fields (i.e., to allow the user to input arbitrary values), or may be selection fields (i.e., to allow the user to choose values from a set of predetermined options). In this manner, long-term settings fields 510 may define long-term patterns of activation of audible alert elements and visible alert elements of intended recipient devices (i.e., as in the above example of the subsequent alert routine). These long-term patterns may effectively be used to maintain the attention of people around an intended recipient device, thus attracting people to the device. That is, the long-term patterns may effectively define a subsequent alert routine to be used to continue alerting people after the initial patterns have finished running, while not annoying, distracting, or otherwise turning people away from the intended recipient device. It should be appreciated that CPU 102 may construct at least a portion of message options 206 based on the settings chosen in long-term settings fields 510. For example, CPU 102 use the settings of long-term audible alert intensity field 510a, long-term audible alert tone field 510b, and long-term audible alert period field 510c to construct second audible alert instruction 214b. CPU 102 may also use the settings of long-term visible alert type field 510d and long-term visible alert period field 510e to construct second visible alert instruction 216b.

Continuing the above example of the initial alert routine and the subsequent alert routine, initial settings fields 508 may be used to define parameters for an initial alert routine (i.e., as defined by audible alert instruction 214a and visible alert instruction 216a) while long-term settings fields 510 may be used to define parameters for a subsequent alert routine (i.e., as defined by audible alert instruction 214b and visible alert instruction 216b). For example, initial audible alert intensity field 508b may be set to ‘high,’ initial audible alert tone field 508c may be set to ‘Tone —ALERT1—Is Continuous Beep,’ and initial audible alert period field 508d may be set to ‘250 milliseconds,’ thus defining an audible response during the initial alert routine that is loud and repetitive to get people's attention. Similarly, long-term audible alert intensity field 510a may be set to ‘low,’ long-term audible alert tone field 510b may be set to ‘Tone 3—WARN1—7 Quick Beeps then 2 Medium Beeps,’ and long-term audible alert period field 510c may be set to ‘30 seconds,’ thus defining an audible response during the subsequent alert routine that is quiet yet periodic to maintain an alert status without inhibiting people's ability to read the text displayed by the device (i.e., the text entered in message text field 502) and to take appropriate action. By setting initial duration field 508a to ‘1 minute,’ the initial alert routine may last about one minute, after which the audible response may change to that of the subsequent alert routine. It should be appreciated that first visible alert instruction 216a may similarly be chosen to attract attention while second visible alert instruction 216b may similarly be chosen to maintain an alert status without inhibiting people's ability to read the text displayed by the device and to take appropriate action.

Peripheral settings checkboxes 512 may generally allow the user to input settings defining which peripheral devices (e.g., devices communicatively coupled with the intended recipient devices, such as, for example, LED marquees) should be activated in response to the alert notification. For example, peripheral settings checkboxes 512 may include an enable other types of devices checkbox, an enable external audible RS232 devices checkbox, an enable assistive technologies for the disabled checkbox, an enable campus cable TV override checkbox, an enable external LED marquee checkbox, an enable external audible devices (e.g., sirens or buzzers) checkbox, an enable external visible RS232 devices checkbox, an enable external text-to-speech checkbox, an enable external TV overlays checkbox, an enable external visible devices (e.g., strobes, etc.) checkbox, a set all high (sets all the i/o ports high) checkbox, and an enable two way communication peripherals (e.g., modem, Ethernet) checkbox. In this manner, the user may control the functionality of peripheral devices in response to a received alert notification. It should be appreciated that the peripheral settings listed above are intended as exemplary only, and that message dispatch interface 500 may alternatively include greater, fewer, or different peripheral settings, if desired. It should also be appreciated that one or more of peripheral settings checkboxes 512 may include settable parameters such as, for example, voltage parameters, or one or more input parameters to be passed to the corresponding peripheral devices by the at least one intended recipient device. CPU 102 may use the settings of peripheral settings checkboxes 512 to construct peripheral device instruction 220.

Alert services checkboxes 514 may generally allow the user to input settings defining which additional alert services should be activated when the alert notification is dispatched. For example, alert services checkboxes 514 may include an SMS checkbox, a telephone auto-dialer checkbox, a pager checkbox, an cable TV overlay checkbox, a plasma overlay checkbox, and an add to RSS checkbox. It should be appreciated that the alert services listed above are intended as exemplary only, and that alert profiles may alternatively include greater, fewer, or different alert services, if desired. It is contemplated that CPU 102 may activate the selected alert services directly or that CPU 102 may transmit instructions to activate the selected alert services to a device communicatively coupled with CPU 102, which may then activate the selected alert services.

It should be appreciated that the options (e.g., ‘Tone 3—WARN1—7 Quick Beeps then 2 Medium Beeps’) illustrated in FIG. 5 and enumerated above are intended as exemplary only and that the disclosed system may include additional and/or different options for the above settings. It should also be appreciated that the settings chosen by a user of the disclosed system may be represented in alert notification architecture 200 in any meaningful way known in the art (e.g., by a unique byte code), which may be interpreted by the intended recipient devices in order to respond according to the chosen settings. As such, the disclosed system may include any options for the above settings that may be interpreted (e.g., decoded and understood) by the intended recipient devices.

It is contemplated that some or all of the settings for the alert notification may be preset. For example, message dispatch interface 500 may include an alert profile selection field (e.g., a drop-down menu of alert profiles), where alert profiles include some or all of the settings available for alert notifications. More specifically, alert profiles may include specified initial settings, long-term settings, peripheral settings, and alert services. Upon selection of an alert profile, computer system 100 may populate initial settings fields 508, long-term settings fields 510, peripheral settings checkboxes 512, and alert services checkboxes 514 with their respective settings from the selected alert profile. It should be appreciated that the user may modify the contents of initial settings fields 508, long-term settings fields 510, peripheral settings checkboxes 512, and/or alert services checkboxes 514 after populating them with the alert profile's settings. It should also be appreciated that computer system 100 may further provide one or more interfaces for creating, modifying, and deleting available alert profiles.

Submit button 516 may allow the user to commit the selected alert notification settings of message dispatch interface 500 to computer system 100. More specifically, by entering data into the components of message dispatch interface 500 and clicking submit button 516, the user of computer system 100 may commit the selected alert notification settings to RAM 104 or ROM 106 of computer system 100, which may then confirm the user's selections before dispatching the alert notification.

FIG. 6 illustrates an exemplary message dispatch confirmation interface 600 which may generally allow a user of computer system 100 to confirm the settings of the alert notification for dispatch. For example, message dispatch confirmation interface 600 may include a visual representation of message text 208, a listing of intended recipient devices 602 (e.g., by group, by device, by geographic region, etc.), a visual representation of total duration 212, a listing of initial settings 604, a listing of long-term settings 606, a listing of peripheral settings 608, a listing of alert services 610, an edit button 612, and a dispatch button 614. The components of message dispatch confirmation interface 600 may visually repeat the settings chosen for the alert notification (i.e., on message dispatch interface 500), and allow the user an opportunity to confirm or edit the settings prior to dispatching the alert notification. If the user chooses to edit the settings, the user may select edit button 612, which may then return the user to message dispatch interface 500. Alternatively, if the user chooses to accept the settings, the user may select dispatch button 614, and CPU 102 may create and send the alert notification consistent with alert notification architecture 200, as discussed above. It is contemplated that message dispatch confirmation interface 600 may alternatively allow the user to modify the settings directly on message dispatch confirmation interface 600 (i.e., rather than redirecting the user back to message dispatch interface 500). It should be appreciated that computer system 100 may confirm the settings of the alert notification in any other method known in the art.

It should be appreciated that computer system 100 may additionally include any number of other GUIs such as, for example, a quick emergency alert notification GUI to quickly send emergency alert notifications while needing only to specify message text 208, or a user management GUI to allow an administrator of the web server user to add, modify, and/or delete user accounts (i.e., control who might have access to send alert notifications and/or edit the settings presented in first, second, and/or third GUI displays).

In one example, computer system 100 may provide a GUI to allow a user to configure alert devices in the field. That is, computer system 100 may allow the user to choose settings for an alert device and convey the settings via a message sent similar to an alert notification. For example, computer system 100 may allow the user to input the geographic location of an alert device. Alternatively, the user may indicate the geographic location of the alert device by, for example, clicking on a map Once the geographic location of the alert device is indicated by the user, CPU 102 may generate a control signal containing the location of the alert device, and transmit it to the alert device (i.e., via interface 112). In this manner, the alert device may become aware of its own location. Similarly, any number of other configurable parameters of the alert device may be specified by the user and transmitted to the alert device by CPU 102. Some other configurable parameters of the alert device may include, for example, the listing of alert device groups in which the alert device is a member, other location information of the alert device (e.g., a zip code, a Federal Information Processing Standards (FIPS) code, or a geocode), an indication of whether the alert device is installed indoors or outdoors, and a listing of one or more external peripheral devices communicatively coupled with the alert device.

The disclosed system and method for creating and delivering alert notifications may provide customizable alert notifications for use with at least one intended recipient device. More specifically, because the disclosed computer system may allow a user to select message text, intended recipients, total duration, initial alert settings, long-term alert settings, peripheral settings, and alert services independently of one another, alert notifications may be created for a maximized variety of alert situations.

The disclosed system and method may also be flexible and applicable to a maximized variety of organizations. More specifically, because the disclosed system and method may be configured to send alert notifications over substantially any communications channel (e.g., a size of the alert notifications may be limited based on a maximum size allowed by a given communications channel), individual organizations can choose a preferred communications channel to use with the disclosed system and method. For example, organizations may choose a communications channel based on availability, cost, and/or other resources, and in this manner, independently operate one or more implementations of the disclosed system. This may allow the organization to deliver specific and timely alert notifications to inform and protect their respective population.

The disclosed system and method may further provide a flexible alerting system. Because the disclosed computer system may include instructions for activating and/or controlling peripheral devices, the computer system may allow organizations to activate a variety of alert devices. More specifically, the computer system may allow organizations to activate alert devices that may not be configured to receive alert notifications from the computer system. For example, organizations may choose to activate an external siren on a case-by-case basis, rather than activating the external siren in response to each received alert notification. Further, because the disclosed computer system may activate one or more alert services in conjunction with dispatching an alert notification, the computer system may additionally be flexible. For example, organizations may choose to send an automated email to a predefined email list when some alert notifications are dispatched.

The disclosed computer system may further still provide a highly-specific addressing instruction allowing alert notifications to be sent to any combination of intended alert devices. More specifically, because the alert notifications can be addressed to specific alert devices, groups of alert devices, and/or one or more geographic regions, the alert notifications can be sent to only those alert devices that should receive the alert notification. That is, depending on the relevance and specificity of a given alert situation, the alert notification for that alert situation can be sent to all of the alert devices that should receive it, and not others.

It will be apparent to those skilled in the art that various modifications and variations can be made in the system and method of the present disclosure without departing from the scope of the invention. Other embodiments may be apparent to those skilled in the art from consideration of the specification and practice of the system and method disclosed herein. It is intended that the specification and examples be considered as exemplary only, with a true scope being indicated by the following claims and their equivalents.

What is claimed is:

1. A computer-readable storage medium for providing an alert notification, comprising instructions for:
configuring an alert text;
configuring at least one audible alert instruction;
configuring at least one visible alert instruction;
constructing an alert notification, including:
the alert text;
the at least one audible alert instruction; and
the at least one visible alert instruction; and
sending the alert notification to at least one intended recipient device.

2. The computer-readable storage medium of claim 1, wherein:
sending the alert notification to the at least one intended recipient device includes broadcasting the alert notification to at least one potential recipient device; and
each of the at least one potential recipient device determines whether it is one of the at least one intended recipient device.

3. The computer-readable storage medium of claim 1, wherein:
sending the alert notification to the at least one intended recipient device includes sending the alert notification to a potential recipient device based on a polling message received from the potential recipient device; and
the potential recipient device determines whether it is one of the at least one intended recipient device.

4. The computer-readable storage medium of claim 1, further including instructions for configuring an addressing instruction, wherein:
the addressing instruction indicates the at least one intended recipient device; and
the addressing instruction is included in the alert notification.

5. The computer-readable storage medium of claim 4, wherein the at least one intended recipient device is indicated by any of an identifier of each of the at least one intended recipient device, an identifier of each of at least one group of the at least one intended recipient device, and a geographic region.

6. The computer-readable storage medium of claim 1, further including instructions for configuring an initial duration of the alert notification, wherein:
the at least one audible alert instruction includes a first audible alert instruction to be executed substantially during the initial duration and a second audible alert instruction to be executed substantially after the initial duration; and
the initial duration is included in the alert notification.

7. The computer-readable storage medium of claim 1, further including instructions for configuring an initial duration of the alert notification, wherein:
the at least one visible alert instruction includes a first visible alert instruction to be executed substantially during the initial duration and a second visible alert instruction to be executed substantially after the initial duration; and
the initial duration is included in the alert notification.

8. The computer-readable storage medium of claim 1, further including instructions for configuring a total duration of the alert notification, wherein the total duration is included in the alert notification.

9. The computer-readable storage medium of claim 1, wherein the alert notification is sent via at least one of a wired network channel and a wireless network channel.

10. The computer-readable storage medium of claim 1, further including instructions for indicating activation of at least one peripheral device, wherein:
the indication of activation of the at least one peripheral device is included in the alert notification; and
the at least one peripheral device is communicatively coupled with the at least one intended recipient device.

11. The computer-readable storage medium of claim 1, further including instructions for indicating activation of at least one alert service.

12. The computer-readable storage medium of claim 1, wherein the alert notification is sent to indicate at least one of an act of violence, an act of terrorism, a hazardous materials incident, severe weather, a mechanical failure, and a technological failure.

13. The computer-readable storage medium of claim 1, wherein:
the alert text includes at least one response guidance message; and
the response guidance message includes instructions for at least one of an evacuation, a lock down, a shelter-in-place of high elevation, and a shelter-in-place of low elevation.

14. An electronic method for providing an alert notification, comprising:
configuring an alert text;
configuring at least one audible alert instruction;
configuring at least one visible alert instruction;
constructing an alert notification, including:
the alert text;
the at least one audible alert instruction; and
the at least one visible alert instruction; and
sending the alert notification to at least one intended recipient device.

15. The electronic method of claim 14, wherein:
sending the alert notification to the at least one intended recipient device includes broadcasting the alert notification to at least one potential recipient device; and
each of the at least one potential recipient device determines whether it is one of the at least one intended recipient device.

16. The electronic method of claim 14, wherein:
sending the alert notification to the at least one intended recipient device includes sending the alert notification to a potential recipient device based on a polling message received from the potential recipient device; and
the potential recipient device determines whether it is one of the at least one intended recipient device.

17. The electronic method of claim 14, further including configuring an addressing instruction indicating the at least one intended recipient device, wherein the addressing instruction is included in the alert notification.

18. The electronic method of claim 17, wherein the at least one intended recipient device is indicated by at least one of an identifier of the at least one intended recipient device, an identifier of each of at least one group of the at least one intended recipient device, and a geographic region.

19. The electronic method of claim 14, further including configuring an initial duration of the alert notification, wherein:
the at least one audible alert instruction includes a first audible alert instruction to be executed substantially during the initial duration and a second audible alert instruction to be executed substantially after the initial duration; and
the initial duration is included in the alert notification.

20. The electronic method of claim 14, further including configuring an initial duration of the alert notification, wherein:
the at least one visible alert instruction includes a first visible alert instruction to be executed substantially during the initial duration and a second visible alert instruction to be executed substantially after the initial duration; and
the initial duration is included in the alert notification.

21. The electronic method of claim 14, further including configuring a total duration of the alert notification, wherein the total duration is included in the alert notification.

22. The electronic method of claim 14, further including indicating activation of at least one peripheral device, wherein:
the indication of activation of the at least one peripheral device is included in the alert notification; and
the at least one peripheral device is communicatively coupled with the at least one intended recipient device.

23. The electronic method of claim 14, further including indicating activation of at least one alert service.

24. The electronic method of claim 14, wherein the alert notification is sent to indicate at least one of an act of violence, an act of terrorism, a hazardous materials incident, severe weather, a mechanical failure, and a technological failure.

25. The electronic method of claim 14, wherein:
the alert text includes at least one response guidance message; and
the response guidance message includes instructions for at least one of an evacuation, a lock down, a shelter-in-place of high elevation, and a shelter-in-place of low elevation.

26. An electronic method, comprising sending an alert notification from an input device to a network, wherein the alert notification includes:
an alert text;
an addressing instruction indicating at least one intended recipient device of the alert notification;
a first audible alert instruction for the at least one intended recipient;
a second audible alert instruction for the at least one intended recipient;
a first visible alert instruction for the at least one intended recipient;
a second visible alert instruction for the at least one intended recipient;
a total duration of the alert notification; and
an initial duration of the alert notification, where the initial duration applies to at least the first audible alert instruction and the first visible alert instruction.
